(19) United States
(12) Patent Application Publication
(10) Pub. No.: US 2023/0269286 A1
(43) Pub. Date: Aug. 24, 2023

(54) CONVERGENCE OF UNICAST AND BROADCAST FOR VIDEO STREAMING

(71) Applicant: QUALCOMM Incorporated, San Diego, CA (US)

(72) Inventors: Yiqing CAO, Beijing (CN); Thomas STOCKHAMMER, Bergen (DE); Zhimin DU, Beijing (CN); Yan LI, Beijing (CN); Jiangsheng WANG, Shanghai (CN)

(21) Appl. No.: 18/013,222

(22) PCT Filed: Aug. 14, 2020
(86) PCT No.: PCT/CN2020/109127

§ 371 Date: Dec. 27, 2022

(51) Int. Cl. H04L 65/611; H04L 65/80; H04L 65/612

(52) U.S. Cl. CPC H04L 65/611; H04L 65/80; H04L 65/612

(57) ABSTRACT

The present disclosure relates to methods and devices for wireless communication including an apparatus, e.g., a UE and/or one or more networks. In one aspect, the apparatus receives an MBMS video streaming service through broadcast from a first network. In addition, the apparatus determines a failure in association with the reception of the broadcasted MBMS video streaming service. Further, the apparatus receives, based on the determined failure of the broadcasted MBMS video streaming service, the MBMS video streaming service through unicast from a second network. In one configuration, the apparatus transmits information to the second network indicating that the MBMS video streaming service through broadcast from the first network has failed. In such a configuration, the MBMS video streaming service through unicast from the second network is received based on the transmitted information.

### CROSS REFERENCE TO RELATED APPLICATIONS

This application is a National Stage Application filed under 35 U.S.C § 371 of PCT

International Application No. PCT/CN2020/109127, entitled “CONVERGENCE OF UNICAST AND BROADCAST FOR VIDEO STREAMING” filed Aug. 14, 2020, which is incorporated herein by reference in its entirety.

### BACKGROUND

### Technical Field

The present disclosure relates generally to communication systems, and more particularly, to converging unicast and broadcast for video streaming.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced (pc) mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a multimedia broadcast multicast service (MBMS) video streaming service through broadcast from a first network. The first network may be a broadcast network. The apparatus may also determine a failure in association with the reception of the broadcasted MBMS video streaming service. Additionally, the apparatus may also receive, based on the determined failure of the broadcasted MBMS video streaming service, the MBMS video streaming service through unicast from a second network. The second network may be a unicast network. In one aspect, the first network may be a broadcast network and the second network may be a unicast network. In one aspect, the first network and the second network may be included in the same network. In another aspect, the first network and the second network may be included in different networks.

In another aspect of the disclosure, a method, a computer-readable medium, and an apparatus are provided. The apparatus may be a unicast network. The apparatus may receive information from a UE indicating that an MBMS video streaming service through broadcast from a first network has failed, the MBMS video streaming service being associated with a content delivery network (CDN). The apparatus may also receive, based on the received information, remaining packet data units (PDUs) in association with the MBMS video streaming service from the CDN. Additionally, the apparatus may transmit, to the UE through unicast, the remaining PDUs in association with the MBMS video streaming service. In one aspect, the first network may be a broadcast network and the second network may be a unicast network. In one aspect, the first network and the second network may be included in the same network. In another aspect, the first network and the second network may be included in different networks.

In another aspect of the disclosure, a method, a computer-readable medium, and an apparatus are provided. The apparatus may be a content delivery network. The apparatus may send a first set of PDUs associated with an MBMS video streaming service to a first network for broadcast transmission to a UE. The apparatus may also receive, from a second network, a request for a second set of PDUs associated with the MBMS video streaming service. Additionally, the apparatus may send, based on the received request, the second set of PDUs associated with the MBMS video streaming service to the second network for unicast transmission to the UE. In one aspect, the first network may be a broadcast network and the second network may be a unicast network. In one aspect, the first network and the second network may be included in the same network. In another aspect, the first network and the second network may be included in different networks.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example broadcast video streaming process from a network to a UE in accordance with one or more techniques of the present disclosure.

FIG. 5 is a diagram illustrating communication between a UE and at least one network within the service layer architecture to provide convergence of unicast and broadcast in accordance with one or more techniques of the present disclosure.

FIG. 6 is a diagram illustrating communication between a UE and at least one network within the streaming architecture to provide convergence of unicast and broadcast in accordance with one or more techniques of the present disclosure.

FIG. 7 is a diagram illustrating protocol layers which enables convergence of unicast and broadcast in accordance with one or more techniques of the present disclosure.

FIG. 8 is a flowchart of a method of wireless communication performed by a UE or a component of a UE in accordance with one or more techniques of the present disclosure.

FIG. 9 is a flowchart of a method of wireless communication performed by a unicast network in accordance with one or more techniques of the present disclosure.

FIG. 10 is a flowchart of a method of wireless communication performed by a CDN in accordance with one or more techniques of the present disclosure.

FIG. 11 is a diagram illustrating an example of a hardware implementation for a UE.

FIG. 12 is a diagram illustrating an example of a hardware implementation for a unicast network.

FIG. 13 is a diagram illustrating an example of a hardware implementation for a CDN.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

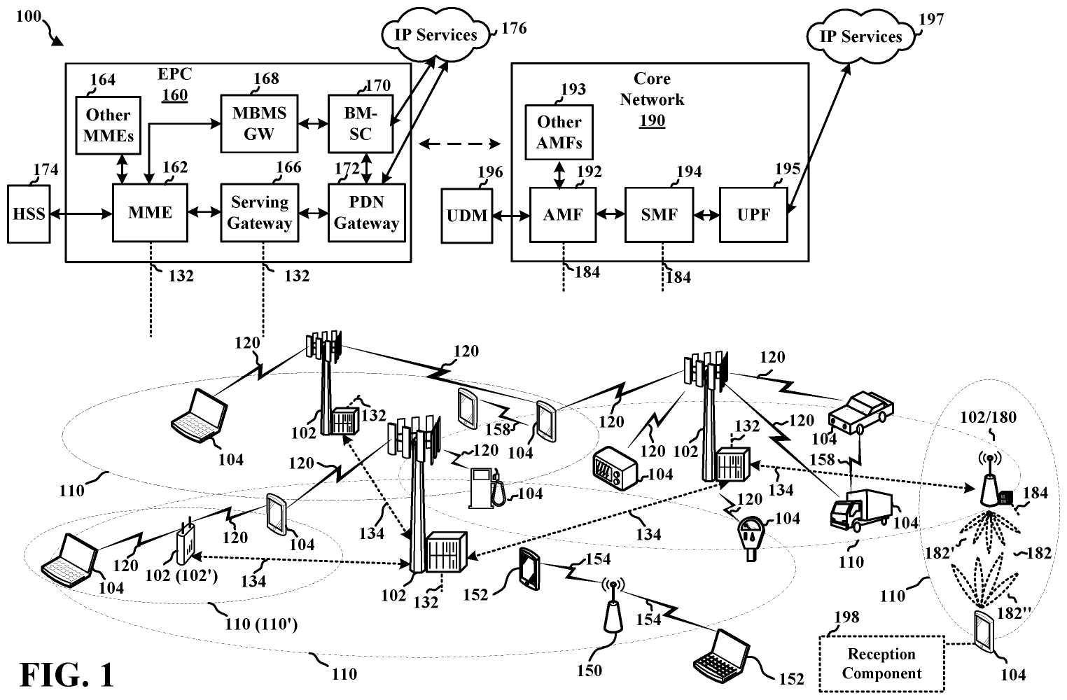

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronic s Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMEs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive an MBMS video streaming service through broadcast from a broadcast network. Reception component 198 may also be configured to determine a failure in association with the reception of the broadcasted MBMS video streaming service. Reception component 198 may also be configured to receive, based on the determined failure of the broadcasted MBMS video streaming service, the MBMS video streaming service through unicast from a unicast network.

Although the following description may be focused on 5G NR, the concepts described herein may be applicable to other similar areas, such as LTE, LTE-A, CDMA, GSM, and other wireless technologies.

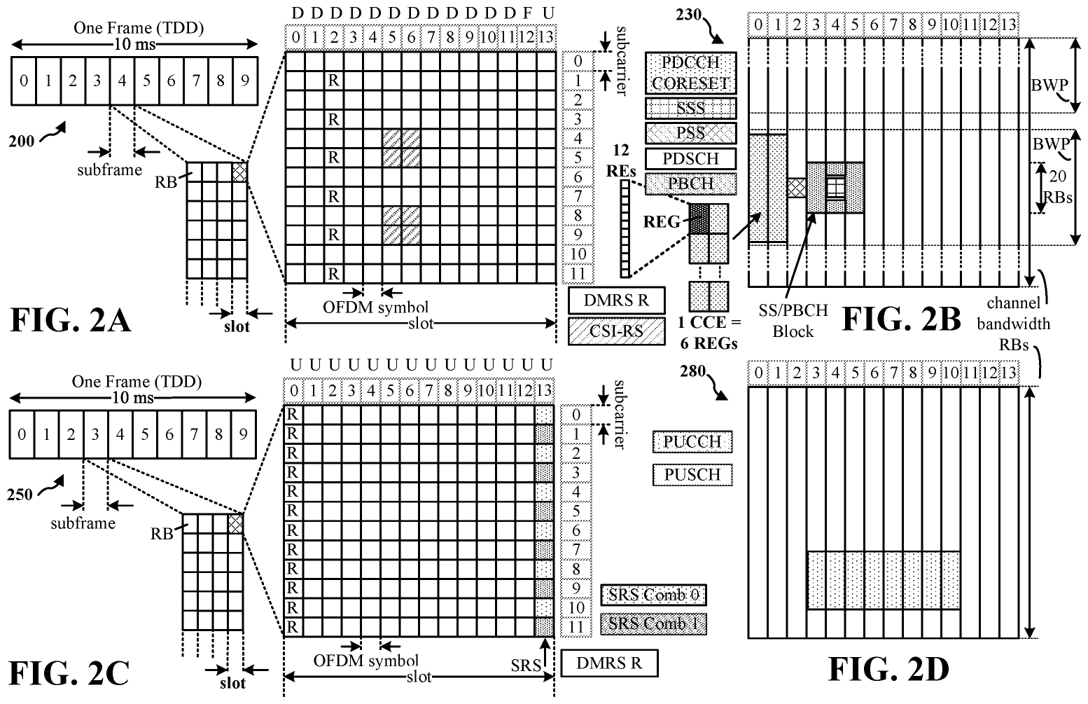

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) ACK/NACK feedback. The PUSCH carries data, and may additionally be used to carry a buffer status report (BSR), a power headroom report (PHR), and/or UCI.

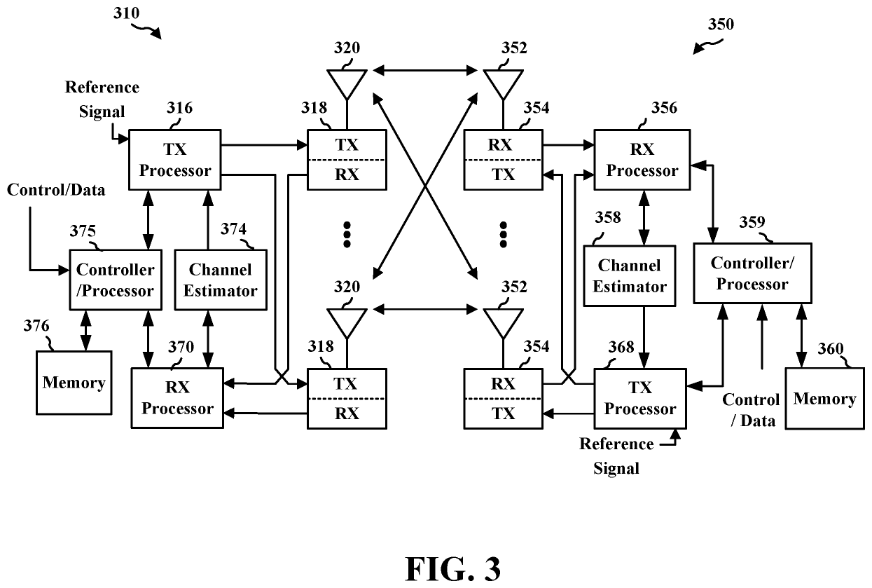

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

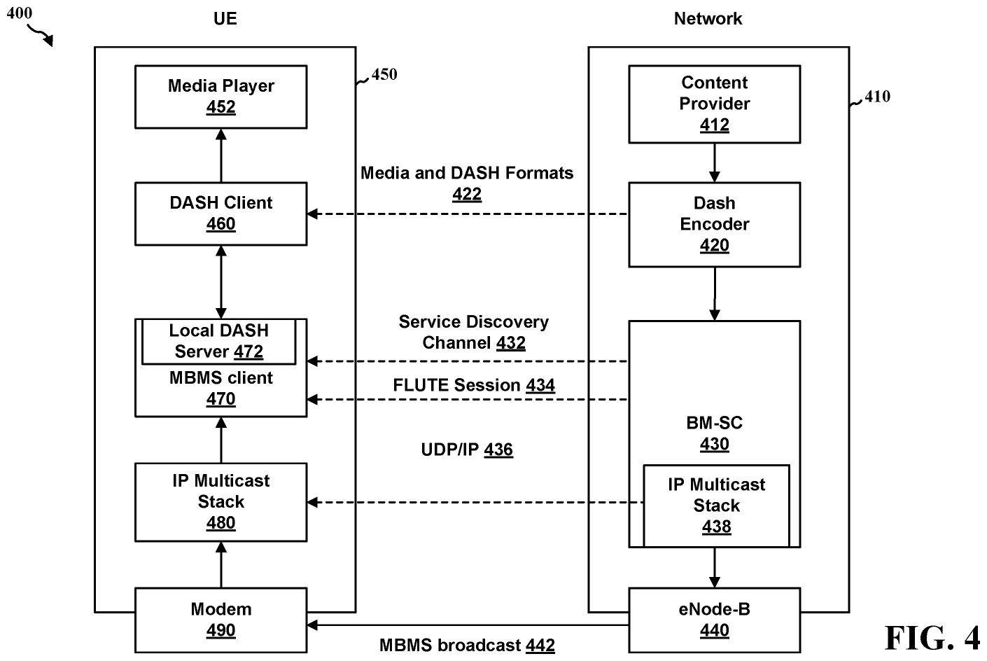

FIG. 4 is a diagram 400 illustrating an example broadcast video streaming process from a network 410 to a UE 450. As shown in FIG. 4, the network 410 may include a content provider 412, a Dynamic Adaptive Streaming over HyperText Transfer Protocol (HTTP) (DASH) encoder 420, a Broadcast Multicast Service Center (BM-SC) 430, and a base station 440. In one aspect, the DASH encoder 420 may reside within the content provider 412. When a real-time streaming service is provided as a Multimedia Broadcast Multicast Service (MBMS), the UE 450 may receive Media Presentation Description (MPD) updates in a File delivery over Unidirectional Transport (FLUTE) session 434 with the media segments. In one aspect, the FLUTE is carried over User Datagram Protocol/Internet Protocol (UDP/IP) 436. Also, the UE 450 may receive a list of available MBMS user services through a service discovery channel 432. In one aspect, the BM-SC 430 may include IP Multicast Stack 438 which delivers data from the BM-SC 430 to the UE 450 through the base station (e.g., eNode-B) 440.

As shown in FIG. 4, the UE 450 may include a media player 452, a DASH client 460, an MBMS client 470, an IP Multicast Stack 480, and a modem 490. The modem 490 may receive the IP Multicast traffic of the MBMS broadcast video streaming 442 from the base station 440 and may route the IP Multicast traffic to the IP Multicast Stack 480 and then to the MBMS client 470. In one aspect, the MBMS client 470 may include a local DASH server 472 to serve the DASH client 460. The DASH client 460 may receive Media and DASH encoded data 422. The Media and DASH encoded data 422 may be played on the media player 452.

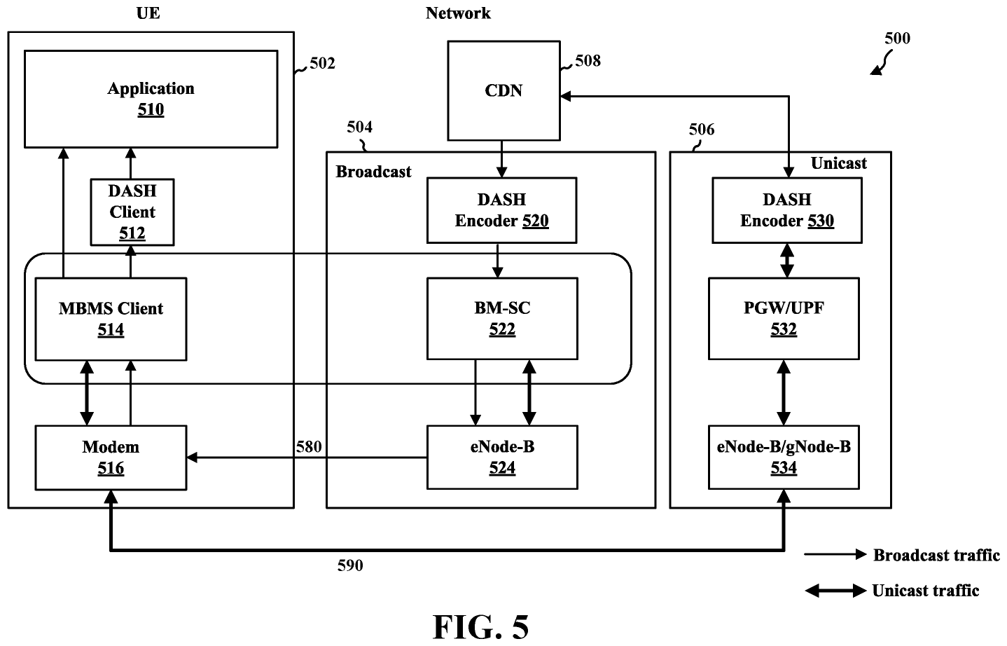

FIG. 5 is a diagram 500 illustrating communication between a UE 502 and at least one network 504, 506, 508 within the service layer architecture to provide convergence of unicast and broadcast. In FIG. 5, the network 504 may be a broadcast network and the network 506 may be a unicast network. The networks 504, 506 may be in communication with the content delivery network 508. As shown in FIG. 5, the communication process between the UE 502 and the broadcast network 504/the content delivery network 508 may provide similar broadcast video streaming service as shown in FIG. 4.

As shown in FIG. 5, the UE 502 may include a modem 516, an MBMS client 514, a DASH client 512, and an application 510 to display the streamed video. The broadcast network 504 may include a DASH encoder 520, a BM-SC 522, a base station (e.g., eNode-B) 524. The unicast network 506 may include a DASH encoder 530, a packet delivery network (PDN) gateway (PGW)/user plane function (UPF) 532, and a base station (e.g., eNode-B or gNode-B) 534. In one aspect, one or both of the DASH encoders 520, 530 may reside in the content delivery network 508.

In some aspects, the UE 502, specifically the modem 516 at the UE 502, may receive an MBMS video streaming service through broadcast 580 from the base station 524 at the broadcast network 504. The UE 502 may then determine that a failure has occurred in association with the reception of the broadcasted MBMS video streaming service. The UE 502 may transmit information 590 to the unicast network 506, specifically to the base station 534, indicating that the MBMS video streaming service through broadcast from the broadcast network 504 has failed. Subsequently, the UE 502 may receive the remaining MBMS video streaming service through unicast 590 from the unicast network 506.

More specifically, the UE 502 may receive a first set of packet data units (PDUs) from the broadcast network 504 with respect to an MBMS video streaming service 580. Upon determining an error in the reception of the MBMS video streaming service, the UE 502 may inform 590 the unicast network 506 of the error. In response, the UE 502 may receive from the unicast network 506 a second set of PDUs in association with the MBMS video streaming service 590. The MBMS client 514 at the UE 502 may be configured to combine and/or order the received PDUs in the first and second set of PDUs for delivery to the application 510 at the UE 502.

In some aspects, when the UE 502 determines that a failure in association with the reception of the broadcasted MBMS video streaming service has failed, at least one of the PGW or the UPF 532 at the unicast network 506 may receive the remaining PDUs in association with the MBMS video streaming service. The at least one of the PGW or the UPF 532 may also provide the remaining PDUs in association with the MBMS video streaming service to a base station 534 at the unicast network 506 for the transmission through unicast to the UE 502. The broadcast network 504 and the unicast network 506 may be part of the same network or may be different networks. The CDN could be a separate network from the broadcast and unicast networks 504, 506, or could be part of one of the broadcast network 504 or the unicast network 506.

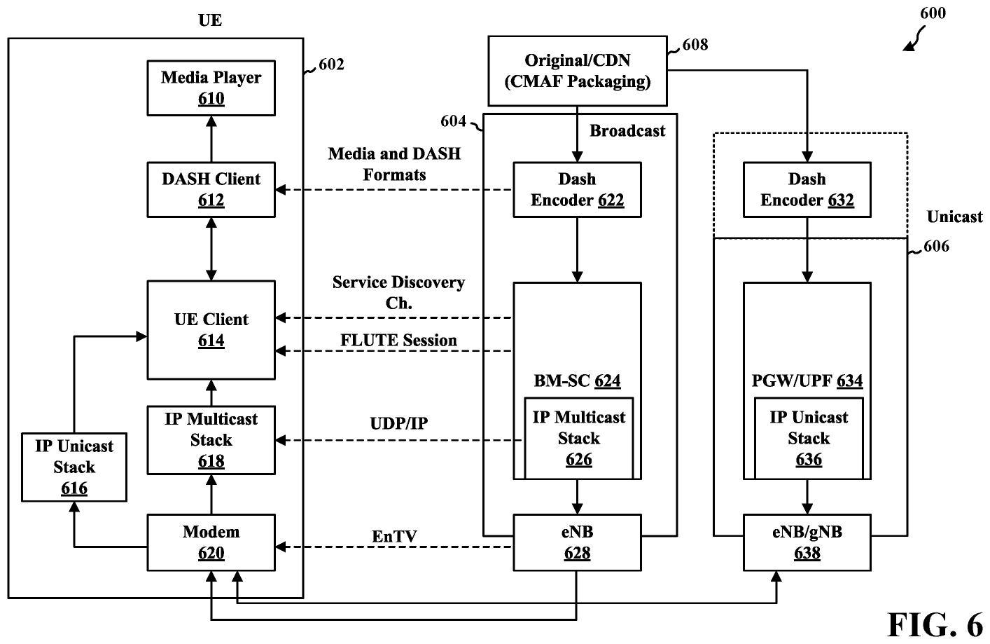

FIG. 6 is a diagram 600 illustrating communication between a UE 602 and at least one network 604, 606, 608 within the streaming architecture to provide convergence of unicast and broadcast. In FIG. 6, the network 604 is a broadcast network, the network 606 is a unicast network, and the networks 604, 606 are in communication with the content delivery network 608. As shown in FIG. 6, the UE 602 may include a modem 620, an IP Unicast Stack 616, an IP Multicast Stack 618, a UE client 614, a DASH client 612, and a media player 610 to display the streamed video. The broadcast network 604 may include a DASH encoder 622, a BM-SC 624 including an IP Multicast Stack 626, a base station (e.g., eNode-B) 628. The unicast network 606 may include a DASH encoder 632, a packet delivery network (PDN) gateway (PGW)/user plane function (UPF) 634 including an IP Unicast Stack 636, and a base station (e.g., eNode-B or gNode-B) 638. In one configuration, the DASH encoder 632 is part of the unicast network 606. In another configuration, the DASH encoder 632 is part of the CDN 608.

In some aspects, the UE 602, specifically the modem 620 at the UE 602, may receive an MBMS video streaming service through broadcast from the base station 628 at the broadcast network 604. The modem 620 may send the broadcast to the UE client 614 through the IP Multicast Stack 618. The UE 602 may then determine that a failure has occurred in association with the reception of the broadcasted MBMS video streaming service. The UE 602 may transmit information to the unicast network 606, specifically to the base station 638, indicating that the MBMS video streaming service through broadcast from the broadcast network 604 has failed. Subsequently, the UE 602, specifically the modem 620 at the UE 602, may receive the remaining MBMS video streaming service through unicast from the base station 638 of the unicast network 606. The modem 620 may then send the broadcast to the UE client 614 through the IP Unicast Stack 616.

More specifically, the UE 602 may receive a first set of PDUs from the broadcast network 604 with respect to an MBMS video streaming service. Upon determining an error in the reception of the MBMS video streaming service, the UE 602 may inform the unicast network 606 of the error. In response, the UE 602 may receive from the unicast network 606 a second set of PDUs in association with the MBMS video streaming service. The UE client 614 at the UE 602 may be configured to combine and/or order the received PDUs in the first and second set of PDUs for delivery to the media player 610 at the UE 602.

In some aspects, when the UE 602 determines that a failure in association with the reception of the broadcasted MBMS video streaming service has failed, at least one of the PGW or the UPF 634 at the unicast network 606 may receive the remaining PDUs in association with the MBMS video streaming service. The at least one of the PGW or the UPF 634 may also provide the remaining PDUs in association with the MBMS video streaming service to a base station 638 at the unicast network 606 for the transmission through unicast to the UE 602.

As discussed above, the CDN sends PDUs associated with a MBMS video streaming service to the broadcast network 604. The PDUs are broadcasted by the broadcast network 604 to the UE 602. When the UE 602 determines that the MBMS video streaming service from the broadcast network 604 has failed, the UE 602 sends information to the unicast network 606 indicating such a failure. The unicast network 606 receives the information from the UE 602 indicating that the MBMS video streaming service through broadcast from the broadcast network 604 has failed. Upon receiving the indication from the UE 602 that the MBMS video streaming service with the broadcast network 604 has failed, the unicast network 606 communicate s with the CDN 608 to receive remaining PDUs in association with the MBMS video streaming service that the UE was receiving from the broadcast network 604. Specifically, the unicast network 606 sends a request for remaining PDUs from the CDN 608. The CDN 608 receives the request for the remaining PDUs from the unicast network 606, and sends the remaining PDUs to the unicast network 606. The unicast network 606 transmits the received remaining PDUs to the UE 602.

In a first configuration, the DASH encoder 632 is at the unicast network 606 and receives the remaining PDUs associated with the MBMS video streaming service from the CDN 608. In such a configuration, the DASH encoder 632 provides the remaining PDUs to the PGW/UPF 634. Subsequently, the PGW/UPF 634 provides the remaining PDUs to the base station 638 at the unicast network 606, where the base station 638 transmits through unicast the remaining PDUs to the UE 602. In a second configuration, the DASH encoder 632 is at the CDN 608. In such a configuration, the PGW/UPF 634 receives the remaining PDUs in association with the MBMS video streaming service from the DASH encoder 632. Subsequently, the PGW/UPF 634 provides the remaining PDUs to the base station 638 at the unicast network 606, where the base station 638 transmits through unicast the remaining PDUs to the UE 602. The broadcast and unicast networks 604, 606 may be part of the same network or may be different networks.

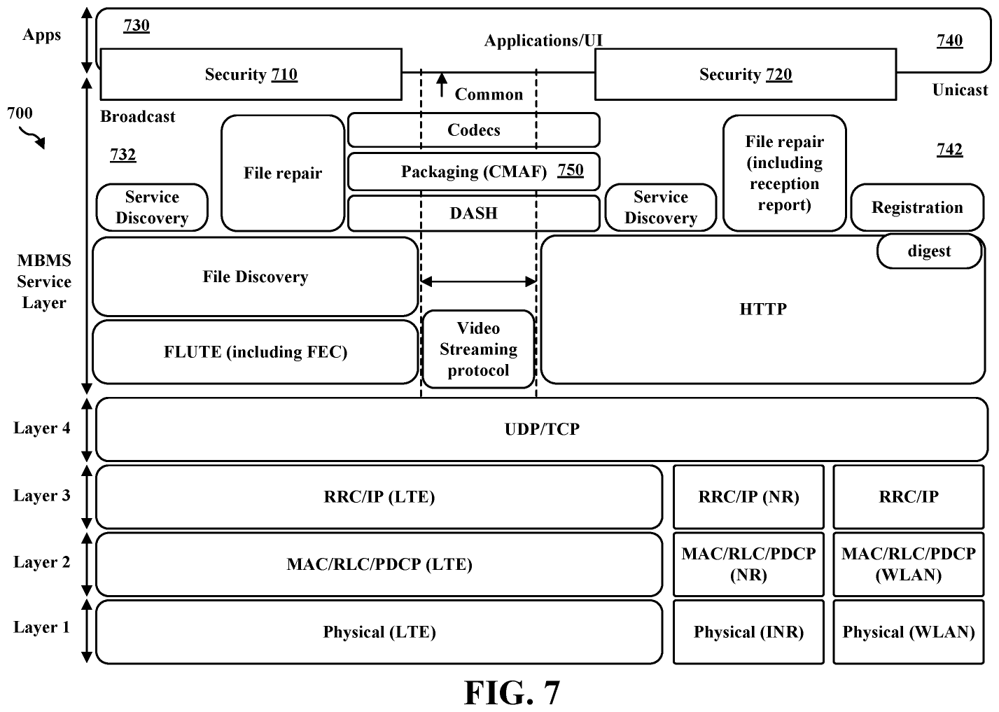

FIG. 7 is a diagram 700 illustrating protocol layers which enables convergence of unicast and broadcast. As shown in FIG. 7, the protocol layers may include Layers 1-4, an MBMS Service Layer for broadcasts 732, an MBMS Service Layer for unicast 742, an application layer for broadcast 730, and an application layer for unicast 740. As shown in FIG. 7, the MBMS video streaming service may be transmitted through broadcast and unicast in a common media application format (CMAF) 750. The MBMS video streaming service may be transmitted through unicast through one of LTE, NR, or Wi-Fi. Also, the transmission of the MBMS video streaming service through broadcast may be secured through a security part 710 in at least one of an application layer at the UE or an MBMS service layer at the UE. Further, the transmission of the MBMS video streaming service through unicast is secured through another security part 720 in at least one of an application layer at the UE or an MBMS service layer at the UE.

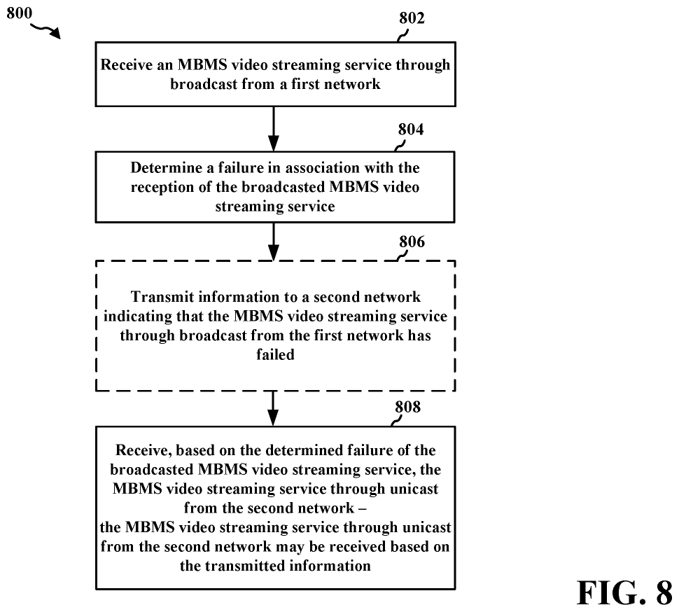

FIG. 8 is a flowchart 800 of a method of wireless communication. The method may be performed by a UE or a component of a UE (e.g., the UE 104, 350; a processing system, which may include the memory 360 and which may be the entire UE or a component of the UE, such as the TX processor 368, the controller/processor 359, transmitter 354TX, antenna(s) 352, and/or the like). Optional aspects are illustrated with a dashed line. The methods described herein can provide a number of benefits, such as improving video streaming process and providing efficient broadcast capabilities.

In one aspect, the UE may receive, at 802, an MBMS video streaming service through broadcast from a first network. For example, as described in connection with the examples in FIGS. 4, 5, and 6, the UE 502 may receive an MBMS video streaming service through broadcast 580 from a broadcast network 504/604. The UE may then determine, at 804, a failure in association with the reception of the broadcasted MBMS video streaming service 580, as described in connection with the examples in FIGS. 4, 5, and 6.

The UE may then receive, at 808, based on the determined failure of the broadcasted MBMS video streaming service, the MBMS video streaming service through unicast from a second network. For example, as described in connection with the examples in FIGS. 4, 5, and 6, the UE may receive, based on the determined failure of the broadcasted MBMS video streaming service, the MBMS video streaming service through unicast 590 from a unicast network 506/606. In one configuration, at 806 the UE may transmit information to the second network indicating that the MBMS video streaming service through broadcast from the first network has failed. In such a configuration, at 808, the MBMS video streaming service through unicast 590 from the second network may be received based on the transmitted information.

In some aspects, the UE may receive a first set of PDUs from the first network with respect to an MBMS video streaming service. Upon determining an error in the reception of the MBMS video streaming service, the UE may inform the second network of the error. In response, the UE may receive from the second network a second set of PDUs in association with the MBMS video streaming service. The MBMS client at the UE may be configured to combine and/or order the received PDUs in the first and second set of PDUs for delivery to the media player at the UE.

In some aspects, the first network and the second network are different networks. In some aspects, the first network and the second network are the same network. Also, the MBMS video streaming service is received in a CMAF through broadcast and unicast. In some aspects, the MBMS video streaming service is received through broadcast from the first network through one of LTE, NR, or Wi-Fi. In other aspects, the MBMS video streaming service is received through unicast through one of LTE, NR, or Wi-Fi. Also, the reception of the MBMS video streaming service through broadcast is secured through a security part in at least one of an application layer at the UE or an MBMS service layer at the UE. Further, the reception of the MBMS video streaming service through unicast is secured through a security part in at least one of an application layer at the UE or an MBMS service layer at the UE.

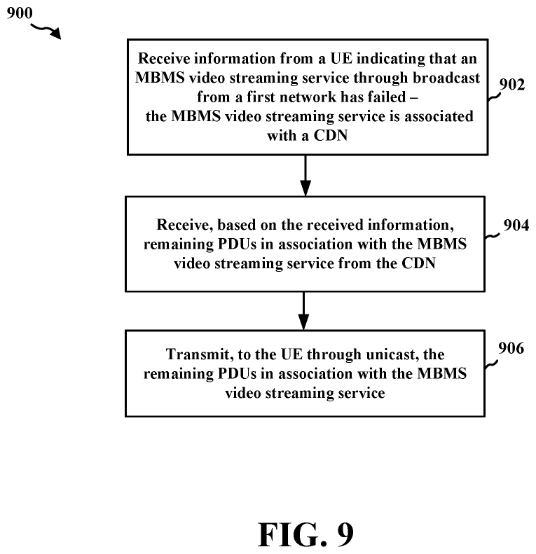

FIG. 9 is a flowchart 900 of a method of wireless communication. The method may be performed by a second network, for example, a unicast network. The methods described herein can provide a number of benefits, such as improving video streaming process and providing efficient broadcast capabilities.

In one aspect, at 902, the second network 506/606 may receive information from the UE 502/602 indicating that an MBMS video streaming service associated with the CDN 508/608 through broadcast from a first network 504/604 has failed. At 904, the second network 506/606 may receive, based on the received information from the UE, remaining PDUs in association with the MBMS video streaming service from the CDN 508/608. At 906, the second network 506/606 may then transmit to the UE 502/602 through unicast, the remaining PDUs in association with the MBMS video streaming service.

In some aspects, a DASH encoder at the unicast network may receive the remaining PDUs in association with the MBMS video streaming service from the CDN. In some aspects, the DASH encoder at the unicast network may provide the remaining PDUs in association with the MBMS video streaming service from the CDN to at least one of a PGW or UPF at the unicast network. Also, at least one of the PGW or the UPF at the unicast network may receive the remaining PDUs in association with the MBMS video streaming service, and may provide the remaining PDUs in association with the MBMS video streaming service to a base station at the unicast network for the transmission through unicast to the UE. Further, at least one of a PGW or UPF at the unicast network may receive the remaining PDUs in association with the MBMS video streaming service from the CDN.

In some aspects, at least one of the PGW or the UPF at the unicast network may receive the remaining PDUs in association with the MBMS video streaming service from a DASH encoder at the CDN. In some aspects, at least one of the PGW or the UPF may provide the remaining PDUs in association with the MBMS video streaming service from the CDN to a base station at the unicast network for the transmission through unicast to the UE. In one configuration, the first network and the second network are different networks. In another configuration, the first network and the second network are the same network. In some aspects, the MBMS video streaming service may be transmitted through broadcast and unicast in a CMAF. In other aspects, the MBMS video streaming service may be transmitted through unicast through one of LTE, NR, or Wi-Fi.

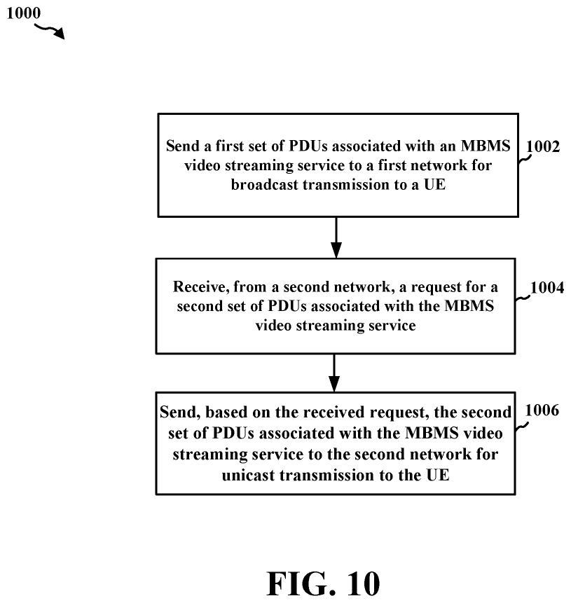

FIG. 10 is a flowchart 1000 of a method of wireless communication. The method may be performed by a CDN. The methods described herein can provide a number of benefits, such as improving video streaming process and providing efficient broadcast capabilities.

In some aspects, the CDN may send, at 1002, a first set of PDUs associated with an MBMS video streaming service to a first network for broadcast transmission to a UE. The CDN may receive, at 1004, from a second network, a request for a second set of PDUs associated with the MBMS video streaming service. The CDN may send, at 1006, based on the received request, the second set of PDUs associated with the MBMS video streaming service to the unicast network for unicast transmission to the UE.

In some aspects, the second set of PDUs may be sent to the second network by a DASH encoder at the CDN. In some aspects, the second set of PDUs may be sent by the DASH encoder at the CDN to at least one of a PGW or UPF at the second network.

In some aspects, the second set of PDUs may be sent to the DASH encoder at the second network. In one configuration, the first network and the second network are different networks. In another configuration, the first network and the second network are the same network.

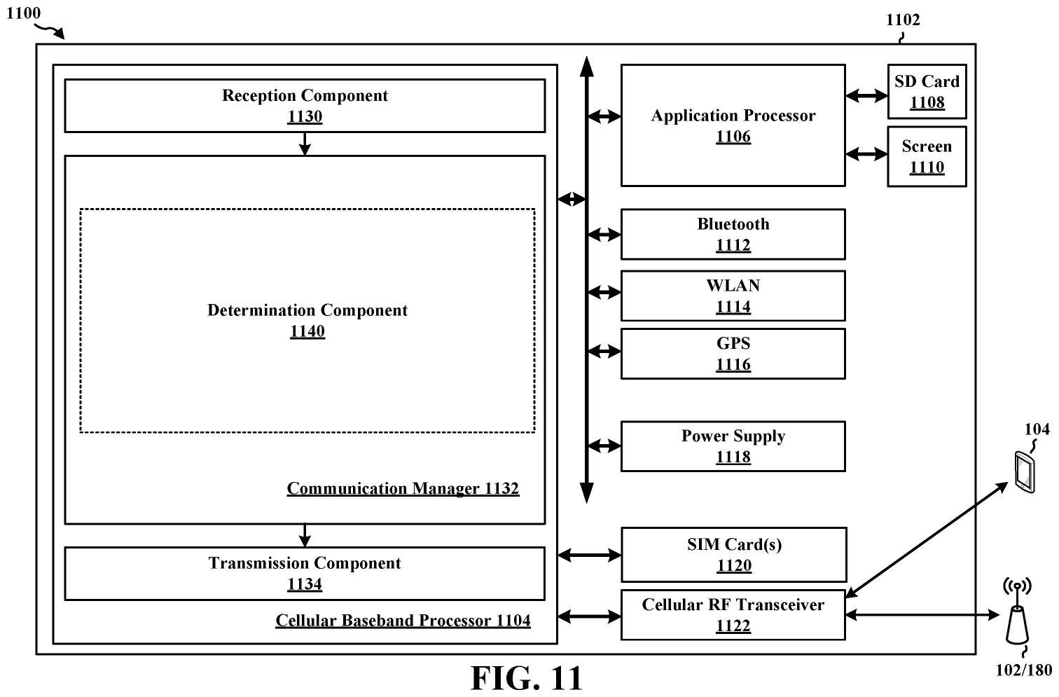

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforediscussed additional modules of the apparatus 1102.

In some aspects, the reception component 1130 may be configured to receive an MBMS video streaming service through broadcast from a broadcast network. The communication manager 1132 includes a determination component 1140 that may be configured to determine a failure in association with the reception of the broadcasted MBMS video streaming service. Also, transmission component 1134 may be configured to transmit information to the unicast network indicating that the MBMS video streaming service through broadcast from the broadcast network has failed. In one configuration, the MBMS video streaming service through unicast from the unicast network is received by the reception component 1130 based on the transmitted information. Further, the reception component 1130 may be configured to receive, based on the determined failure of the broadcasted MBMS video streaming service, the MBMS video streaming service through unicast from a unicast network.

The apparatus may include additional components that perform each of the blocks of the algorithm in the aforementioned flowcharts of FIGS. 8, 9, and 10. As such, each block in the aforementioned flowcharts of FIGS. 8, 9, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for receiving a MBMS video streaming service through broadcast from a broadcast network. The apparatus 1102 can also include means for determining a failure in association with the reception of the broadcasted MBMS video streaming service. The apparatus 1102 can also include means for receiving, based on the determined failure of the broadcasted MBMS video streaming service, the MBMS video streaming service through unicast from a unicast network. The apparatus 1102 can also include means for transmitting information to the unicast network indicating that the MBMS video streaming service through broadcast from the broadcast network has failed. The MBMS video streaming service through unicast from the unicast network may be received based on the transmitted information. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

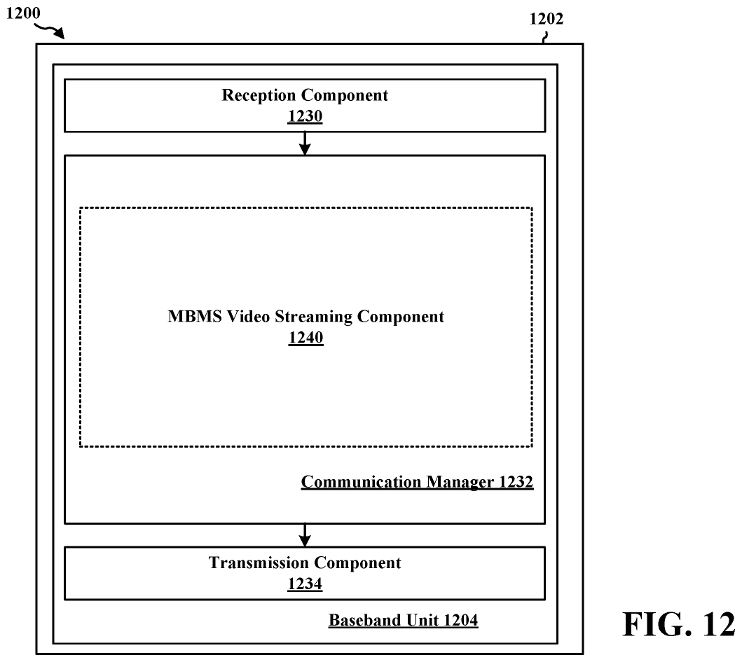

FIG. 12 is a diagram 1200 illustrating an example of a hardware implementation for an apparatus 1202. The apparatus 1202 is a unicast network and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234 which includes a determination component 1240. The communication manager 1232 includes the one or more illustrated components. The components within the communication manager 1232 may be stored in the computer-readable medium/memory and/or configured as hardware within the baseband unit 1204.

The reception component 1230 is configured to receive information from the UE indicating that an MBMS video streaming service associated with the CDN through broadcast from a broadcast network has failed. The reception component 1230 may also receive, based on the received information from the UE, remaining PDUs in association with the MBMS video streaming service from the CDN. The MBMS video streaming component 1240 may communicate with the reception component 1230 and with the transmission component 1234. Based on the communication, the transmit component 1234 may then transmit, to the UE through unicast, the remaining PDUs in association with the MBMS video streaming service.

The apparatus 1202 may include additional components that perform each of the blocks of the algorithm in the aforementioned flowcharts of FIGS. 8, 9, and 10. As such, each block in the aforementioned flowcharts of FIGS. 8, 9, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for receiving information from the UE indicating that an MBMS video streaming service associated with the CDN through broadcast from a broadcast network has failed. The baseband unit 1204 may also include means for receiving, based on the received information from the UE, remaining PDUs in association with the MBMS video streaming service from the CDN. The baseband unit 1204 may also include means for transmitting, to the UE through unicast, the remaining PDUs in association with the MBMS video streaming service. The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

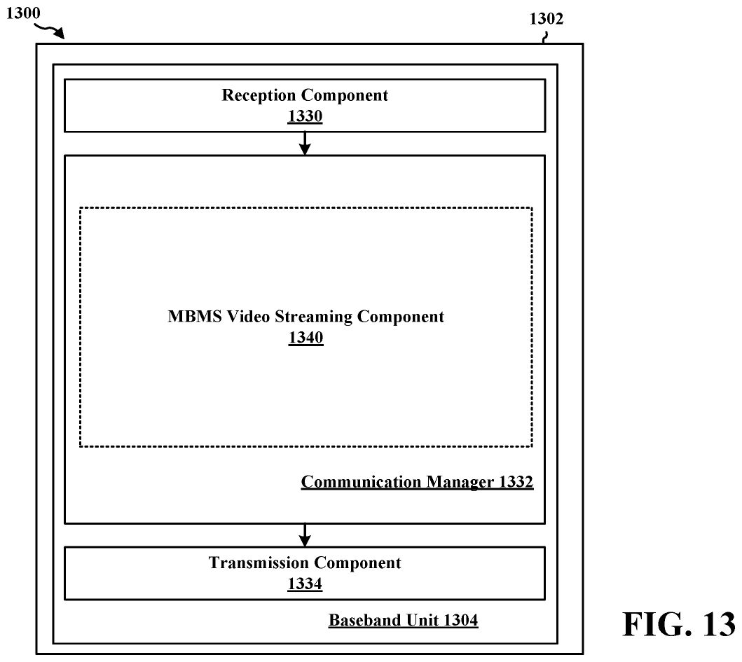

FIG. 13 is a diagram 1300 illustrating an example of a hardware implementation for an apparatus 1302. The apparatus 1302 is a CDN and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334 which includes a determination component 1340. The communication manager 1332 includes the one or more illustrated components. The components within the communication manager 1332 may be stored in the computer-readable medium/memory and/or configured as hardware within the baseband unit 1304.

The transmission component 1334 may be configured to send a first set of PDUs associated with an MBMS video streaming service to a broadcast network for broadcast transmission to a UE. The reception component 1330 may be configured to receive from a unicast network, a request for a second set of PDUs associated with the MBMS video streaming service. The MBMS video streaming component 1340 may be configured to process the received request, and to communicate with the transmission component 1334. The transmission component 1334 is also configured to transmit based on the received request, the second set of PDUs associated with the MBMS video streaming service to the unicast network for unicast transmission to the UE.

The apparatus 1302 may include additional components that perform each of the blocks of the algorithm in the aforementioned flowcharts of FIGS. 8, 9, and 10. As such, each block in the aforementioned flowcharts of FIGS. 8, 9, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for sending a first set of PDUs associated with an MBMS video streaming service to a broadcast network for broadcast transmission to a UE. The baseband unit 1304 may also include means for receiving from a unicast network, a request for a second set of PDUs associated with the MBMS video streaming service. The baseband unit 1304 may also include means for transmitting based on the received request, the second set of PDUs associated with the MBMS video streaming service to the unicast network for unicast transmission to the UE. The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a multimedia broadcast multicast service (MBMS) video streaming service through broadcast from a first network;
determining a failure in association with the reception of the broadcasted MBMS video streaming service; and
receiving, based on the determined failure of the broadcasted MBMS video streaming service, the MBMS video streaming service through unicast from a second network.

2. The method of claim 1, further comprising transmitting information to the second network indicating that the MBMS video streaming service through broadcast from the first network has failed, wherein the MBMS video streaming service through unicast from the second network is received based on the transmitted information.

3. The method of claim 1, wherein a first set of packet data units (PDUs) are received in association with the MBMS video streaming service through broadcast from the first network, and a second set of PDUs are received in association with the MBMS video streaming service through unicast from the second network, the method further comprising combining in order the first set of PDUs and the second set of PDUs for delivery at an application layer of the UE.

4. The method of claim 1, wherein the first network and the second network are different networks.

5. The method of claim 1, wherein the first network is a broadcast network and the second network is a unicast network, and wherein the first network and the second network are included in the same network.

6. The method of claim 1, wherein the MBMS video streaming service is received in a common media application format (CMAF) through broadcast and unicast.

7. The method of claim 1, wherein the MBMS video streaming service is received through broadcast from the first network through one of Long Term Evolution (LTE), New Radio (NR), or Wi-Fi, and is received through unicast through one of LTE, NR, or Wi-Fi.

8. The method of claim 1, wherein the reception of the MBMS video streaming service through broadcast is secured through a security part in at least one of an application layer at the UE or an MBMS service layer at the UE.

9. The method of claim 1, wherein the reception of the MBMS video streaming service through unicast is secured through a security part in at least one of an application layer at the UE or an MBMS service layer at the UE.

10. An apparatus for wireless communication of a user equipment (UE), comprising:
a memory; and
at least one processor coupled to the memory and configured to:
receive a multimedia broadcast multicast service (MBMS) video streaming service through broadcast from a first network;
determine a failure in association with the reception of the broadcasted MBMS video streaming service; and
receive, based on the determined failure of the broadcasted MBMS video streaming service, the MBMS video streaming service through unicast from a second network.

11. The apparatus of claim 10, wherein the at least one processor is further configured to transmit information to the second network indicating that the MBMS video streaming service through broadcast from the first network has failed, wherein the MBMS video streaming service through unicast from the second network is received based on the transmitted information.

12. The apparatus of claim 10, wherein a first set of packet data units (PDUs) are received in association with the MBMS video streaming service through broadcast from the first network, and a second set of PDUs are received in association with the MBMS video streaming service through unicast from the second network, wherein the at least one processor is further configured to combine in order the first set of PDUs and the second set of PDUs for delivery at an application layer of the UE.

13. The apparatus of claim 10, wherein the first network and the second network are different networks.

14. The apparatus of claim 10, wherein the first network is a broadcast network and the second network is a unicast network, and wherein the first network and the second network are included in the same network.

15. The apparatus of claim 10, wherein the MBMS video streaming service is received in a common media application format (CMAF) through broadcast and unicast.

16. The apparatus of claim 10, wherein the MBMS video streaming service is received through broadcast from the first network through one of Long Term Evolution (LTE), New Radio (NR), or Wi-Fi, and is received through unicast through one of LTE, NR, or Wi-Fi.

17. The apparatus of claim 10, wherein the reception of the MBMS video streaming service through broadcast is secured through a security part in at least one of an application layer at the UE or an MBMS service layer at the UE.

18. The apparatus of claim 10, wherein the reception of the MBMS video streaming service through unicast is secured through a security part in at least one of an application layer at the UE or an MBMS service layer at the UE.

19. An apparatus for wireless communication of a user equipment (UE), comprising:
means for receiving a multimedia broadcast multicast service (MBMS) video streaming service through broadcast from a first network;
means for determining a failure in association with the reception of the broadcasted MBMS video streaming service; and
means for receiving, based on the determined failure of the broadcasted MBMS video streaming service, the MBMS video streaming service through unicast from a second network.

20. The apparatus of claim 19, further comprising means for transmitting information to the second network indicating that the MBMS video streaming service through broadcast from the first network has failed, wherein the MBMS video streaming service through unicast from the second network is received based on the transmitted information.

21. The apparatus of claim 19, wherein a first set of packet data units (PDUs) are received in association with the MBMS video streaming service through broadcast from the first network, and a second set of PDUs are received in association with the MBMS video streaming service through unicast from the second network, the apparatus further comprising means for combining in order the first set of PDUs and the second set of PDUs for delivery at an application layer of the UE.

22. The apparatus of claim 19, wherein the first network and the second network are different networks.

23. The apparatus of claim 19, wherein the first network is a broadcast network and the second network is a unicast network, and wherein the first network and the second network are included in the same network.

24. The apparatus of claim 19, wherein the MBMS video streaming service is received in a common media application format (CMAF) through broadcast and unicast.

25. The apparatus of claim 19, wherein the MBMS video streaming service is received through broadcast from the first network through one of Long Term Evolution (LTE), New Radio (NR), or Wi-Fi, and is received through unicast through one of LTE, NR, or Wi-Fi.

26. The apparatus of claim 19, wherein the reception of the MBMS video streaming service through broadcast is secured through a security part in at least one of an application layer at the UE or an MBMS service layer at the UE.

27. The apparatus of claim 19, wherein the reception of the MBMS video streaming service through unicast is secured through a security part in at least one of an application layer at the UE or an MBMS service layer at the UE.

28. A computer-readable medium storing computer executable code for wireless communication of a user equipment (UE), the code when executed by a processor causes the processor to:
receive a multimedia broadcast multicast service (MBMS) video streaming service through broadcast from a first network;
determine a failure in association with the reception of the broadcasted MBMS video streaming service; and
receive, based on the determined failure of the broadcasted MBMS video streaming service, the MBMS video streaming service through unicast from a second network.

29. A method of wireless communication of a second network, comprising:
receiving information from a user equipment (UE) indicating that a multimedia broadcast multicast service (MBMS) video streaming service through broadcast from a first network has failed, the MBMS video streaming service being associated with a content delivery network (CDN);
receiving, based on the received information, remaining packet data units (PDUs) in association with the MBMS video streaming service from the CDN; and
transmitting, to the UE through unicast, the remaining PDUs in association with the MBMS video streaming service.

30. The method of claim 29, wherein a dynamic adaptive streaming over hypertext transfer protocol (HTTP) (DASH) encoder at the second network receives the remaining PDUs in association with the MBMS video streaming service from the CDN.

31. The method of claim 30, wherein the DASH encoder at the second network provides the remaining PDUs in association with the MBMS video streaming service from the CDN to at least one of a packet delivery network (PDN) gateway (PGW) or user plane function (UPF) at the second network.

32. The method of claim 31, wherein the at least one of the PGW or the UPF at the second network receives the remaining PDUs in association with the MBMS video streaming service, and provides the remaining PDUs in association with the MBMS video streaming service to a base station at the second network for the transmission through unicast to the UE.

33. The method of claim 29, wherein at least one of a packet delivery network (PDN) gateway (PGW) or user plane function (UPF) at the second network receives the remaining PDUs in association with the MBMS video streaming service from the CDN.

34. The method of claim 33, wherein the at least one of the PGW or the UPF at the second network receives the remaining PDUs in association with the MBMS video streaming service from a dynamic adaptive streaming over hypertext transfer protocol (HTTP) (DASH) encoder at the CDN.

35. The method of claim 33, wherein the at least one of the PGW or the UPF provides the remaining PDUs in association with the MBMS video streaming service from the CDN to a base station at the second network for the transmission through unicast to the UE.

36. The method of claim 29, wherein the first network and the second network are different networks.

37. The method of claim 29, wherein the first network is a broadcast network and the second network is a unicast network, and wherein the first network and the second network are included in the same network.

38. The method of claim 29, wherein the MBMS video streaming service is transmitted through unicast in a common media application format (CMAF).

39. The method of claim 29, wherein the MBMS video streaming service is transmitted through unicast through one of Long Term Evolution (LTE), New Radio (NR), or Wi-Fi.

40. An apparatus for wireless communication, the apparatus being a second network, comprising:
a memory; and
at least one processor coupled to the memory and configured to:
receive information from a user equipment (UE) indicating that a multimedia broadcast multicast service (MBMS) video streaming service through broadcast from a first network has failed, the MBMS video streaming service being associated with a content delivery network (CDN);
receive, based on the received information, remaining packet data units (PDUs) in association with the MBMS video streaming service from the CDN; and
transmit, to the UE through unicast, the remaining PDUs in association with the MBMS video streaming service.

41. The apparatus of claim 40, wherein a dynamic adaptive streaming over hypertext transfer protocol (HTTP) (DASH) encoder at the second network receives the remaining PDUs in association with the MBMS video streaming service from the CDN.

42. The apparatus of claim 41, wherein the DASH encoder at the second network provides the remaining PDUs in association with the MBMS video streaming service from the CDN to at least one of a packet delivery network (PDN) gateway (PGW) or user plane function (UPF) at the second network.

43. The apparatus of claim 42, wherein the at least one of the PGW or the UPF at the second network receives the remaining PDUs in association with the MBMS video streaming service, and provides the remaining PDUs in association with the MBMS video streaming service to a base station at the second network for the transmission through unicast to the UE.

44. The apparatus of claim 40, wherein at least one of a packet delivery network (PDN) gateway (PGW) or user plane function (UPF) at the second network receives the remaining PDUs in association with the MBMS video streaming service from the CDN.

45. The apparatus of claim 44, wherein the at least one of the PGW or the UPF at the second network receives the remaining PDUs in association with the MBMS video streaming service from a dynamic adaptive streaming over hypertext transfer protocol (HTTP) (DASH) encoder at the CDN.

46. The apparatus of claim 44, wherein the at least one of the PGW or the UPF provides the remaining PDUs in association with the MBMS video streaming service from the CDN to a base station at the second network for the transmission through unicast to the UE.

47. The apparatus of claim 40, wherein the first network and the second network are different networks.

48. The apparatus of claim 40, wherein the first network is a broadcast network and the second network is a unicast network, and wherein the first network and the second network are included in the same network.

49. The apparatus of claim 40, wherein the MBMS video streaming service is transmitted through unicast in a common media application format (CMAF).

50. The apparatus of claim 40, wherein the MBMS video streaming service is transmitted through unicast through one of Long Term Evolution (LTE), New Radio (NR), or Wi-Fi.

51. An apparatus for wireless communication, the apparatus being a second network, comprising:
means for receiving information from a user equipment (UE) indicating that a multimedia broadcast multicast service (MBMS) video streaming service through broadcast from a first network has failed, the MBMS video streaming service being associated with a content delivery network (CDN);
means for receiving, based on the received information, remaining packet data units (PDUs) in association with the MBMS video streaming service from the CDN; and
means for transmitting, to the UE through unicast, the remaining PDUs in association with the MBMS video streaming service.

52. The apparatus of claim 51, wherein a dynamic adaptive streaming over hypertext transfer protocol (HTTP) (DASH) encoder at the second network receives the remaining PDUs in association with the MBMS video streaming service from the CDN.

53. The apparatus of claim 52, wherein the DASH encoder at the second network provides the remaining PDUs in association with the MBMS video streaming service from the CDN to at least one of a packet delivery network (PDN) gateway (PGW) or user plane function (UPF) at the second network.

54. The apparatus of claim 53, wherein the at least one of the PGW or the UPF at the second network receives the remaining PDUs in association with the MBMS video streaming service, and provides the remaining PDUs in association with the MBMS video streaming service to a base station at the second network for the transmission through unicast to the UE.

55. The apparatus of claim 51, wherein at least one of a packet delivery network (PDN) gateway (PGW) or user plane function (UPF) at the second network receives the remaining PDUs in association with the MBMS video streaming service from the CDN.

56. The apparatus of claim 55, wherein the at least one of the PGW or the UPF at the second network receives the remaining PDUs in association with the MBMS video streaming service from a dynamic adaptive streaming over hypertext transfer protocol (HTTP) (DASH) encoder at the CDN.

57. The apparatus of claim 55, wherein the at least one of the PGW or the UPF provides the remaining PDUs in association with the MBMS video streaming service from the CDN to a base station at the second network for the transmission through unicast to the UE.

58. The apparatus of claim 51, wherein the first network and the second network are different networks.

59. The apparatus of claim 51, wherein the first network is a broadcast network and the second network is a unicast network, and wherein the first network and the second network are included in the same network.

60. The apparatus of claim 51, wherein the MBMS video streaming service is transmitted through unicast in a common media application format (CMAF).

61. The apparatus of claim 51, wherein the MBMS video streaming service is transmitted through unicast through one of Long Term Evolution (LTE), New Radio (NR), or Wi-Fi.

62. A computer-readable medium storing computer executable code for wireless communication of a second network, the code when executed by a processor causes the processor to:
receive information from a user equipment (UE) indicating that a multimedia broadcast multicast service (MBMS) video streaming service through broadcast from a first network has failed, the MBMS video streaming service being associated with a content delivery network (CDN);
receive, based on the received information, remaining packet data units (PDUs) in association with the MBMS video streaming service from the CDN; and
transmit, to the UE through unicast, the remaining PDUs in association with the MBMS video streaming service.

63. A method of communication at a content delivery network (CDN), comprising:
sending a first set of packet data units (PDUs) associated with a multimedia broadcast multicast service (MBMS) video streaming service to a first network for broadcast transmission to a user equipment (UE);
receiving, from a second network, a request for a second set of PDUs associated with the MBMS video streaming service; and
sending, based on the received request, the second set of PDUs associated with the MBMS video streaming service to the second network for unicast transmission to the UE.

64. The method of claim 63, wherein the second set of PDUs is sent to the second network by a dynamic adaptive streaming over hypertext transfer protocol (HTTP) (DASH) encoder at the CDN.

65. The method of claim 64, wherein the second set of PDUs is sent by the DASH encoder at the CDN to at least one of a packet delivery network (PDN) gateway (PGW) or user plane function (UPF) at the second network.

66. The method of claim 63, wherein the second set of PDUs is sent to a dynamic adaptive streaming over hypertext transfer protocol (HTTP) (DASH) encoder at the second network.

67. The method of claim 63, wherein the first network and the second network are different networks.

68. The method of claim 63, wherein the first network is a broadcast network and the second network is a unicast network, and wherein the first network and the second network are included in the same network.

69. An apparatus for communication at a content delivery network (CDN), comprising:
a memory; and
at least one processor coupled to the memory and configured to:
send a first set of packet data units (PDUs) associated with a multimedia broadcast multicast service (MBMS) video streaming service to a first network for broadcast transmission to a user equipment (UE);
receive, from a second network, a request for a second set of PDUs associated with the MBMS video streaming service; and
send, based on the received request, the second set of PDUs associated with the MBMS video streaming service to the second network for unicast transmission to the UE.

70. The apparatus of claim 69, wherein the second set of PDUs is sent to the second network by a dynamic adaptive streaming over hypertext transfer protocol (HTTP) (DASH) encoder at the CDN.

71. The apparatus of claim 70, wherein the second set of PDUs is sent by the DASH encoder at the CDN to at least one of a packet delivery network (PDN) gateway (PGW) or user plane function (UPF) at the second network.

72. The apparatus of claim 69, wherein the second set of PDUs is sent to a dynamic adaptive streaming over hypertext transfer protocol (HTTP) (DASH) encoder at the second network.

73. The apparatus of claim 69, wherein the first network and the second network are different networks.

74. The apparatus of claim 69, wherein the first network is a broadcast network and the second network is a unicast network, and wherein the first network and the second network are included in the same network.

75. An apparatus for communication at a content delivery network (CDN), comprising:
means for sending a first set of packet data units (PDUs) associated with a multimedia broadcast multicast service (MBMS) video streaming service to a first network for broadcast transmission to a user equipment (UE);
means for receiving, from a second network, a request for a second set of PDUs associated with the MBMS video streaming service; and
means for sending, based on the received request, the second set of PDUs associated with the MBMS video streaming service to the second network for unicast transmission to the UE.

76. The apparatus of claim 75, wherein the second set of PDUs is sent to the second network by a dynamic adaptive streaming over hypertext transfer protocol (HTTP) (DASH) encoder at the CDN.

77. The apparatus of claim 76, wherein the second set of PDUs is sent by the DASH encoder at the CDN to at least one of a packet delivery network (PDN) gateway (PGW) or user plane function (UPF) at the second network.

78. The apparatus of claim 75, wherein the second set of PDUs is sent to a dynamic adaptive streaming over hypertext transfer protocol (HTTP) (DASH) encoder at the second network.

79. The apparatus of claim 75, wherein the first network and the second network are different networks.

80. The apparatus of claim 75, wherein the first network is a broadcast network and the second network is a unicast network, and wherein the first network and the second network are included in the same network.

81. A computer-readable medium storing computer executable code for wireless communication of a content delivery network (CDN), the code when executed by a processor causes the processor to:
send a first set of packet data units (PDUs) associated with a multimedia broadcast multicast service (MBMS) video streaming service to a first network for broadcast transmission to a user equipment (UE);
receive, from a second network, a request for a second set of PDUs associated with the MBMS video streaming service; and
send, based on the received request, the second set of PDUs associated with the MBMS video streaming service to the second network for unicast transmission to the UE.
